(19) United States
(12) Patent Application Publication
(10) Pub. No.: US 2025/0328697 A1
(43) Pub. Date: Oct. 23, 2025

(54) PARAMETRIC EDITING OF PRE-DEFINED TEMPLATES FOR SPATIAL LAYOUTS

(71) Applicant: Henry Products Incorporated, Seattle, WA (US)

(72) Inventors: Maxwell Mahler HUDSON, Seattle, WA (US); Elton S. HUDSON, Vashon, WA (US); Joseph Preston TEMPLETON PLEVER, Durham, NC (US)

(21) Appl. No.: 18/886,141

(22) Filed: Sep. 16, 2024

Related U.S. Application Data
(60) Provisional application No. 63/636,519, filed on Apr. 19, 2024.

(51) Int. Cl. G06F 30/13

(52) U.S. Cl. CPC G06F 30/13

(57) ABSTRACT

Techniques for populating a digital twin that is representative of a spatial layout by parametrically modifying a pre-defined template having characteristics that satisfy design conditions for the spatial layout are disclosed. A service generates a repository of pre-defined templates that can populate various different types of digital twins. Each template has a corresponding theme and a corresponding set of objects. The service receives design conditions for a spatial layout. Based on the design conditions, the service generates a digital twin of the spatial layout. Based on the design conditions, the service selects one of the templates. The service populates the digital twin using the pre-defined template. The population includes performing a parametric modification to the template.

### CROSS-REFERENCE TO RELATED APPLICATIONS

This application claims the benefit of and priority to U.S. Provisional Patent Application Ser. No. 63/636,519 filed on Apr. 19, 2024 and entitled “PARAMETRIC EDITING OF PRE-DEFINED TEMPLATES FOR SPATIAL LAYOUTS,” which application is expressly incorporated herein by reference in its entirety.

### BACKGROUND

Interior design is generally known as the art of enhancing the interior of a building to produce an aesthetically pleasing environment. While not an exhaustive list, the process of designing a room includes selecting equipment, furnishings, window coverings, and so on. Different techniques are used depending on the type of environment. For instance, a warehouse will be organized differently than a salon.

The interior design process generally includes multiple steps. These steps include a design step or phase, a purchasing phase, and a roll out phase. A significant amount of time and energy is involved during each of these steps, but perhaps the most time is spent during the design phase. For instance, a designer needs to understand the dimensions of the room he/she will be working with. The designer also needs to understand how the items in the room will mesh with one another. Although different tools are available to assist designers with the design phase, there are still many areas for improvement. Accordingly, what is needed is an improved tool for assisting designers with placing objects or items in a defined environment.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method for populating a digital twin that is representative of a spatial layout by parametrically modifying a pre-defined template having characteristics that satisfy design conditions for the spatial layout, said method including: generating a repository including a plurality of pre-defined templates that are structured to populate various different types of digital twins that are representative of different spatial layouts, wherein each pre-defined template in the plurality of pre-defined templates has a corresponding theme and includes a corresponding set of objects that supplement said corresponding theme; subsequent to generation of the repository including the plurality of pre-defined templates, receiving design conditions for a spatial layout, wherein the design conditions include spatial dimensions for the spatial layout and a particular theme for the spatial layout; based on the design conditions, generating a digital twin of the spatial layout, wherein the digital twin is structured to have characteristics representative of the design conditions, including the spatial dimensions and the particular theme; based on the design conditions, selecting a pre-defined template from among the plurality of pre-defined templates, wherein the selected pre-defined template is selected as a result of the corresponding set of characteristics for the pre-defined template satisfying, within a threshold level of satisfaction, the design conditions; and populating the digital twin using the pre-defined template, wherein said populating includes performing one or more parametric modifications to the pre-defined template.

In some aspects, the techniques described herein relate to a computer system including: a processor system; and a storage system that stores instructions that are executable by the processor system to cause the computer system to: generate a repository including a plurality of pre-defined templates that are structured to populate various different types of digital twins that are representative of different spatial layouts, wherein each pre-defined template in the plurality of pre-defined templates has a corresponding theme and includes a corresponding set of objects that supplement said corresponding theme; subsequent to generation of the repository including the plurality of pre-defined templates, receive design conditions for a spatial layout, wherein the design conditions include spatial dimensions for the spatial layout and a particular theme for the spatial layout; based on the design conditions, generate a digital twin of the spatial layout, wherein the digital twin is structured to have characteristics representative of the design conditions, including the spatial dimensions and the particular theme; based on the design conditions, select a pre-defined template from among the plurality of pre-defined templates, wherein the selected pre-defined template is selected as a result of the corresponding set of characteristics for the pre-defined template satisfying, within a threshold level of satisfaction, the design conditions; and populate the digital twin using the pre-defined template, wherein said populating includes performing one or more parametric modifications to the pre-defined template.

In some aspects, the techniques described herein relate to a method for populating a digital twin that is representative of a kitchen layout by parametrically modifying a pre-defined template having characteristics that satisfy design conditions for the kitchen layout, said method including: accessing a repository including a plurality of pre-defined templates that are structured to populate various different types of digital twins that are representative of different spatial layouts, wherein each pre-defined template in the plurality of pre-defined templates has a corresponding theme and includes a corresponding set of objects that supplement said corresponding theme; receiving design conditions for a kitchen layout, wherein the design conditions include spatial dimensions for the kitchen layout and a kitchen theme for the kitchen layout; based on the design conditions, generating a digital twin of the kitchen layout, wherein the digital twin is structured to have characteristics representative of the design conditions, including the spatial dimensions and the kitchen theme; based on the design conditions, selecting a pre-defined template from among the plurality of pre-defined templates, wherein the selected pre-defined template is a kitchen template that is selected as a result of the corresponding set of characteristics for the kitchen template satisfying, within a threshold level of satisfaction, the design conditions; and populating the digital twin using the kitchen template, wherein said populating includes performing one or more parametric modifications to the kitchen template.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture that can be used to parametrically edit pre-defined templates for spatial layouts and to generate containers.

FIG. 2 illustrates various examples of different pre-defined templates.

FIG. 3 illustrates different spatial layouts.

FIG. 4 illustrates how a template can be used to populate a digital twin.

FIG. 5 illustrates a populated layout.

FIG. 6 illustrates a modified layout.

FIG. 7 illustrates another populated layout.

FIG. 8 illustrates a modified layout.

FIG. 9 illustrates an example spatial layout having an empty region into which a container can be placed.

FIG. 10 illustrates examples of different containers.

FIG. 11 illustrates the placement of a container.

FIG. 12 illustrates a container.

FIG. 13 illustrates another container.

FIG. 14 illustrates another container.

FIG. 15 illustrates another spatial layout.

FIG. 16 illustrates the placement of a container.

FIG. 17 illustrates a container.

FIG. 18 illustrates how a container can be modified.

FIG. 19 illustrates a reveal between two objects.

FIG. 20 illustrates a flowchart of an example method for parametrically editing a pre-defined template.

FIG. 21 illustrates a flowchart of an example method for generating a container.

FIG. 22 illustrates an example computer system that can be configured to perform any of the disclosed operations.

### DETAILED DESCRIPTION

The disclosed embodiments relate to systems, devices, and methods for populating a digital twin that is representative of a spatial layout. The population of this digital twin can be performed by parametrically modifying a pre-defined template having characteristics that satisfy design conditions for the spatial layout. Additionally, or alternatively, the population of the digital twin can be performed by generating a container that includes one or more objects. The container is insertable into the digital twin of the spatial layout to populate the digital twin with the one or more objects.

As various non-limiting examples, the spatial layout can correspond to a kitchen, a living room, an office, a common room, a bedroom, or any other personal or business environment. The digital twin can be a digital representation of these areas. In one example, suppose the spatial layout is for a kitchen that is to have a U-shape. The pre-defined template can be a kitchen template designed to accommodate the U-shape. This kitchen template can include various different appliances, counters, drawers, cabinets, lighting fixtures, an island, seating fixtures, and so on. Although the kitchen template is pre-defined, it can be automatically customized when placed in the digital twin so as to fit the dimensions of the digital twin. This automatic customization can include various different parametric edits to the template. For example, if the size of one wall in the digital twin is longer than the corresponding wall of the template, the template's countertop can be extended to accommodate the difference in size. Similarly, the number of drawers and/or cabinets can also be automatically updated to fill the void.

Various different objects can be included within a container. As one example, a container may be designed to have a particular container type, such as perhaps a cabinet type. The container can be automatically populated to include a specified number of cabinets that collectively adhere to whatever requirements may be specified for the container. The container can then be inserted into the digital twin. Subsequent global modifications (e.g., parametric modifications) can be applied to the container. For instance, by resizing the overall container, the number of cabinets within the container can be increased, decreased, or caused to remain the same (but the sizes of the existing cabinets may change).

The disclosed embodiments provide numerous benefits, advantages, improvements, and practical applications in how spatial layouts are populated. In particular, the disclosed embodiments provide a service that can surface a user interface. The service and user interface beneficially enable users to design a digital twin of a spatial layout in an intuitive, efficient, and easy manner. In performing the disclosed operations, the embodiments significantly improve how spatial layouts are designed and further improve how users are able to interact with computer systems. Accordingly, these and numerous other benefits will now be described in more detail throughout the remaining sections of this disclosure.

### Example Computing Architecture

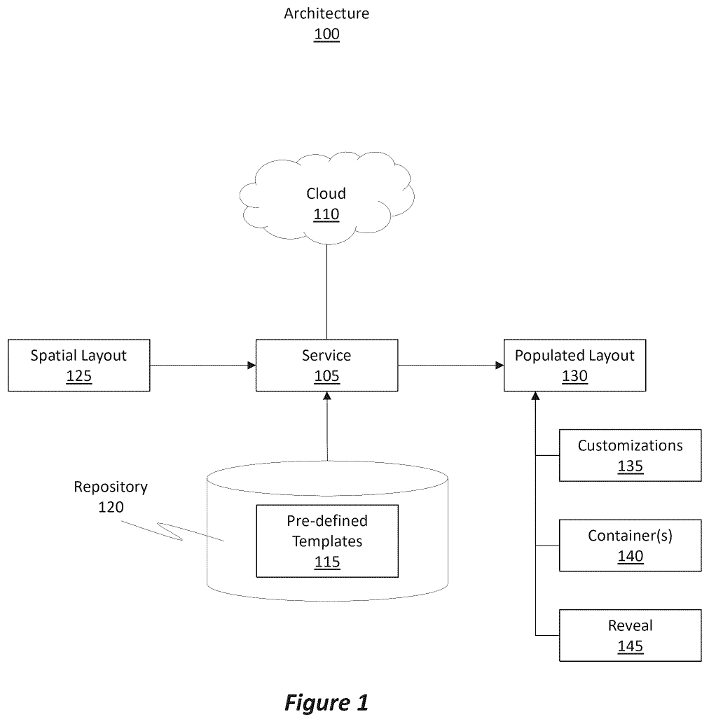

Attention will now be directed to FIG. 1, which illustrates an example architecture 100 that can provide the above benefits and that can be used to intelligently design a digital twin, such as by parametrically modifying a pre-defined template and/or by generating and modifying a container. Architecture 100 is shown as including a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 110 environment. In some implementations, service 105 is a local service operating on a local device. In some implementations, service 105 is a hybrid service that includes a cloud component that communicates with a local component.

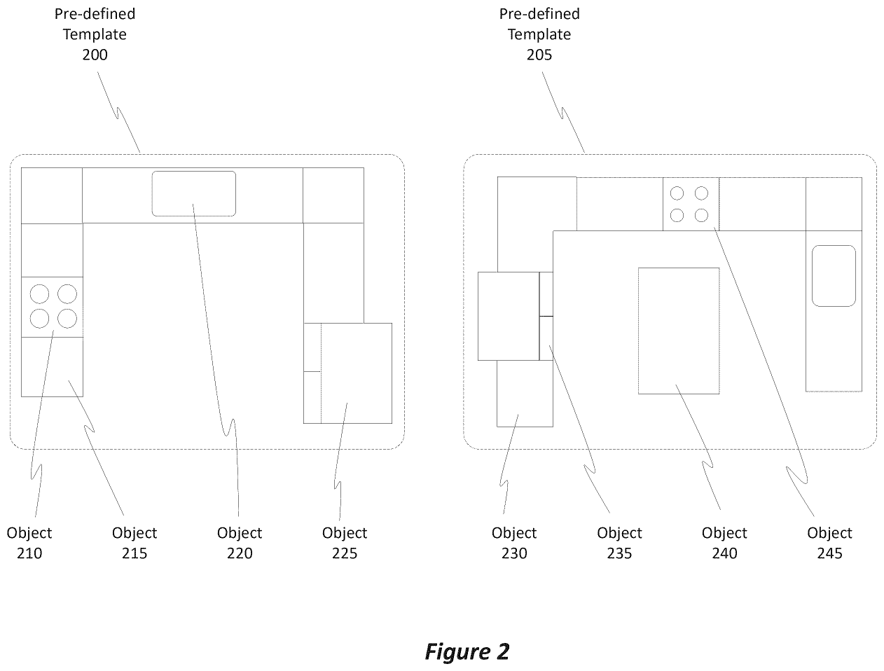

Service 105 is generally tasked with generating a set of pre-defined templates 115, which may be stored in a repository 120. The pre-defined templates 115 may be of any type. For instance, the pre-defined templates 115 may include pre-defined templates that are usable to populate a spatial layout. As one specific example, consider a spatial layout that is destined to operate as a kitchen area for a dwelling. The pre-defined templates can define various kitchen-related objects that are to be installed in the kitchen area. As used herein, the term “object” can refer to any type of feature, appliance, volume, and so on. Examples of objects include, but are not limited to, fridges, cabinets, pantries, sinks, stoves, lighting fixtures, a defined volume reserved for an unspecified purpose, closets, beds, couches, stools, islands, windows, couches, and so on, without limit. FIG. 2 provides some helpful illustrations.

FIG. 2 shows two pre-defined templates, such as pre-defined template 200 and pre-defined template 205. These pre-defined templates may be included among the pre-defined templates 115 of FIG. 1. Both of the pre-defined templates include objects that can be used to populate a kitchen area.

For instance, pre-defined template 200 includes object 210 (e.g., a stovetop), object 215 (e.g., a counter), object 220 (e.g., a sink), and object 225 (e.g., a fridge), among others. Pre-defined template 205 includes object 230 (e.g., a counter), object 235 (e.g., a fridge), object 240 (e.g., an island), and object 245 (e.g., a stovetop), among others. The objects included in a pre-defined template may be selected based on an initial configuration of a spatial layout. For instance, if the spatial layout is to be a kitchen having a U-shape, then the templates can be designed to accommodate those design constraints. Of course, any criteria, constraint, or condition can be accommodated.

Returning to FIG. 1, any number of pre-defined templates 115 can be included in the repository 120. Often, generalized conditions may be used when designing the pre-defined templates. Examples of generalized conditions include commonly used spatial layouts and configurations, commonly used objects within those spatial layouts, and so on without limit.

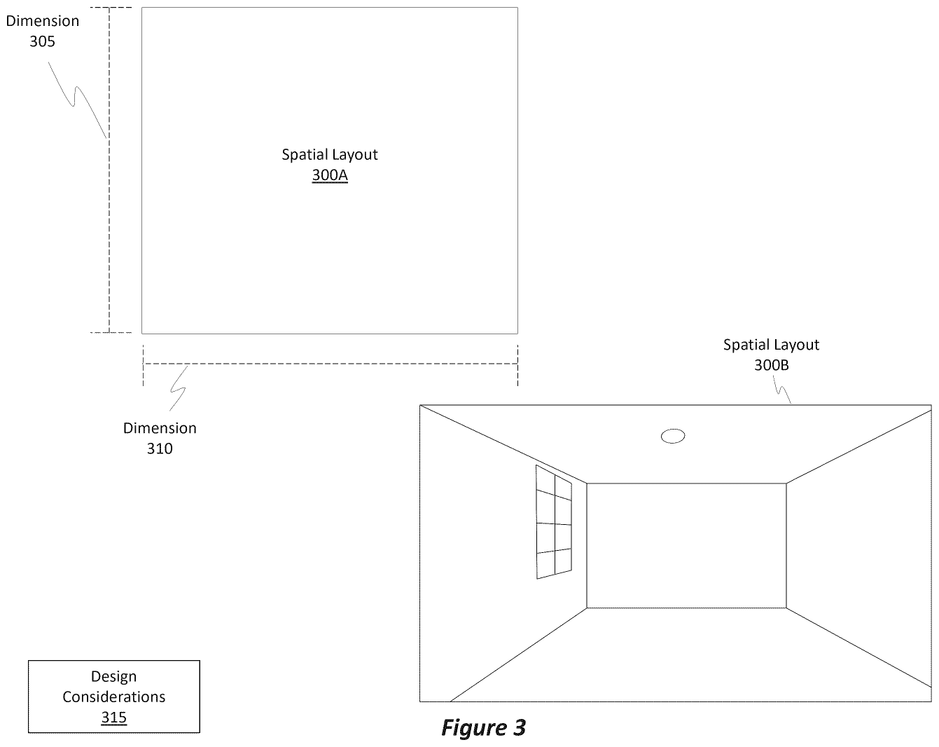

Service 105 can also receive information describing a spatial layout 125. This information may include the dimensions of that spatial layout 125, the purpose or end goal (e.g., theme) for the spatial layout 125 (e.g., is the spatial layout supposed to be a kitchen, bedroom, living room, office, etc.), and any other design criteria. For example, if the spatial layout corresponds to a kitchen, then the theme for the spatial layout will be a kitchen. The theme can help determine which objects are most suitable for placement in the digital twin designed for the spatial layout. For instance, an office desk likely is not suitable for an area having a kitchen them. FIG. 3 is illustrative.

FIG. 3 shows a spatial layout 300A shown from a top aerial perspective and the same spatial layout 300B shown from a front perspective view. These views may be provided within a user interface provided by the service 105. Spatial layout 300A is associated with various dimensions, such as dimension 305 and dimension 310. The spatial layouts 300A/B are also associated with a set of design considerations 315, which may include the purpose of this spatial layout and/or any other parameter.

Returning to FIG. 1, service 105 receives the information relating to the spatial layout. Service 105 can then generate a digital twin of the spatial layout 125, where the digital twin is a digital representation of the spatial layout 125.

After generating this digital twin, service 105 can then intelligently select, from among the pre-defined templates 115, a specific pre-defined template that best suites the spatial layout 125 based on the parameters, dimensions, and other design criteria. Service 105 may then populate the digital twin using the selected pre-defined template, thereby generating a populated layout 130. Notably, this populated layout 130 is generated by parametrically modifying the pre-defined template in a manner so that the template fits within the constraints or physical layout of the digital twin. As used herein, the term “parametric” is often used in conjunction with a model or a pre-defined template. Parametric changes involve modifying the entire shape (or other characteristics) or perhaps specific portions of the template. The embodiments are also configured to support modifying characteristics of individual objects within the template.

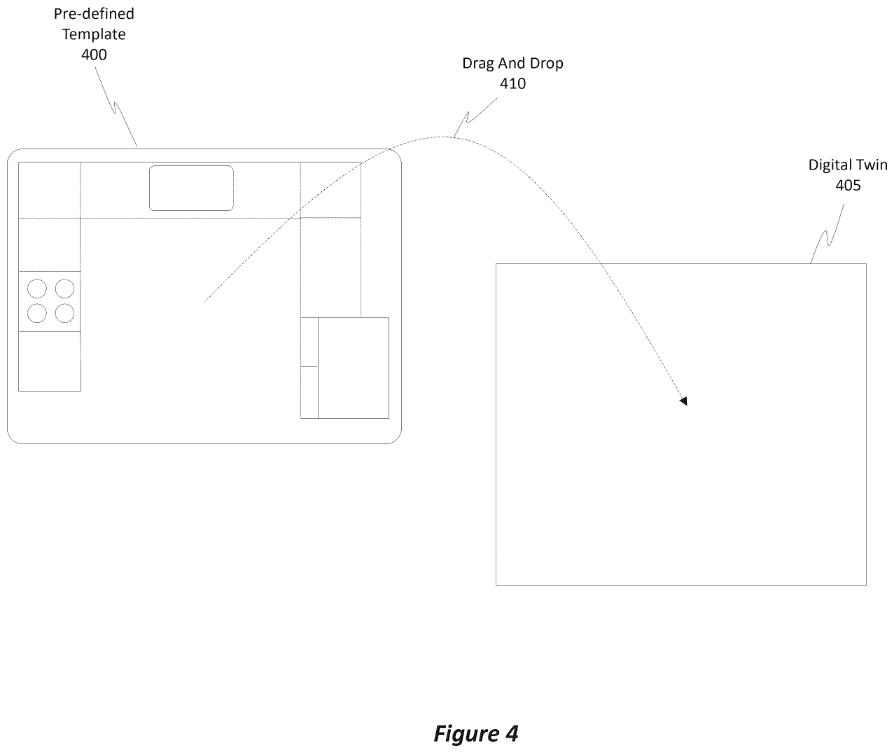

In this regard, service 105 is able to perform parametric editing of an archetype (e.g., a pre-existing design/layout of a space that can be used as a starting point for a design action). Service 105 includes the ability to apply one or more transformations (e.g., movements, scaling, rotations, etc.) to a group of objects linked together (e.g., in the form of a pre-defined template). Service 105 can also apply settings to the archetype to have the objects in the archetype (e.g., the pre-defined template) automatically update when those settings are modified so as to reflect a parametric change. FIGS. 4 through 8 are illustrative.

FIG. 4 shows a pre-defined template 400 that has been selected for a digital twin 405 in accordance with the principles described above. This pre-defined template 400 can be inserted into the digital twin 405 to populate the digital twin 405 with preconfigured objects, as shown by the drag and drop 410 action, which can be performed within a user interface. Of course, other techniques can be used to populate the digital twin 405.

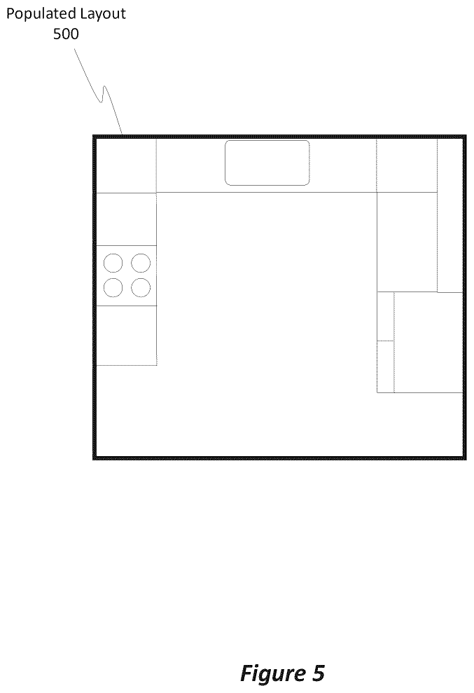

FIG. 5 shows the result of populating the digital twin 405 of FIG. 4 with the pre-defined template 400. In particular, FIG. 5 shows a populated layout 500, which is representative of the populated layout 130 of FIG. 1.

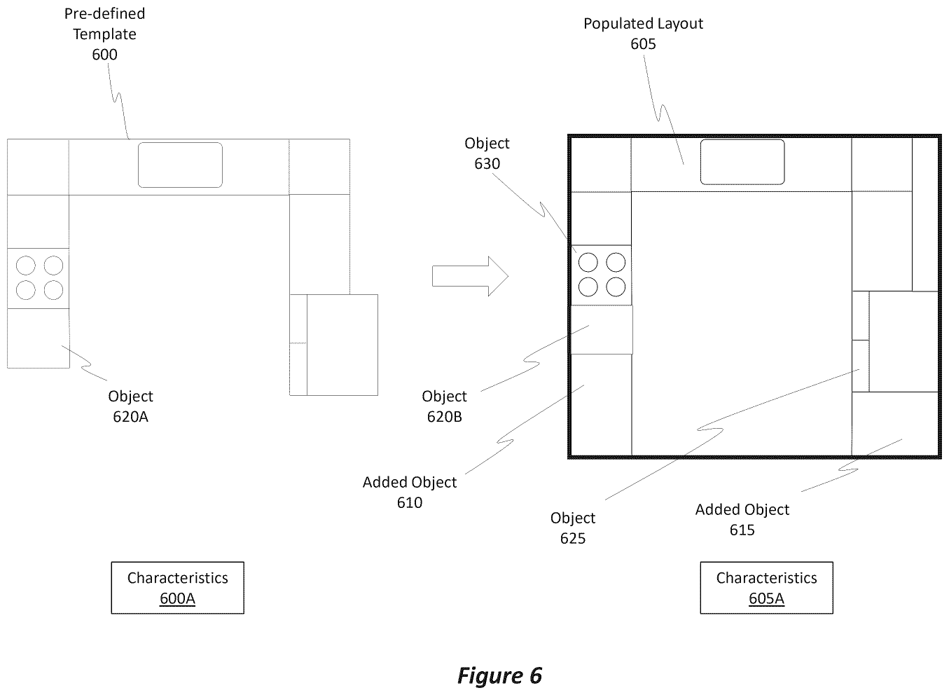

Often, the characteristics of a pre-defined template will not exactly match the characteristics of a spatial layout. For instance, the spatial layout's dimensions might be somewhat different than the dimensions of the pre-defined template. Service 105 of FIG. 1 is designed to account for such differences by dynamically modifying the pre-defined template in a manner so as to properly populate the spatial layout. FIG. 6 is illustrative.

FIG. 6 shows a pre-defined template 600. The pre-defined template 600 was designed based on an initial set of characteristics 600A. FIG. 6 further shows a populated layout 605 that was populated based on the pre-defined template 600. Notice, the populated layout 605 has a set of characteristics 605A that are somewhat different than the characteristics 600A. For instance, one length of the populated layout 605 is longer than the corresponding length of the pre-defined template 600.

Service 105 of FIG. 1 is able to dynamically customize the pre-defined template 600 when it is used to populate the digital twin. This dynamic customization can include modifying existing objects in some manner (e.g., perhaps their sizes) or adding new objects to accommodate the differences in characteristics (e.g., size characteristics or even physical impediments), thereby performing “parametric” modifications. FIG. 6 shows how service 105 added two new objects in response to the pre-defined template 600 populating the digital twin. These two new objects include added object 610 and added object 615.

In some implementations, service 105 includes intelligence to determine which type of new object is to be added. This determination may be based on the properties or characteristics of the immediately proximate object. For instance, the pre-defined template 600 included an object 620A in the form of a counter. Similarly, the populated layout 605 included the object 620B, which is the same counter.

Service 105 can determine that added object 610 is to have the same characteristics as object 620B. Object 625 corresponds to a fridge. Often, fridges are placed in a kitchen near a stove/oven, a counter with drawers, or a pantry. It is rare for a fridge to be placed immediately next to a sink. Service 105 is able to include this situational awareness and understanding. Service 105 can consider this situational understanding when selecting the type for the added object 615. Because object 630 is a stove/oven and because only a single stove/oven is to be included in this design (as specified by the design considerations), service 105 is able to determine that added object 615 would best be a counter with drawers.

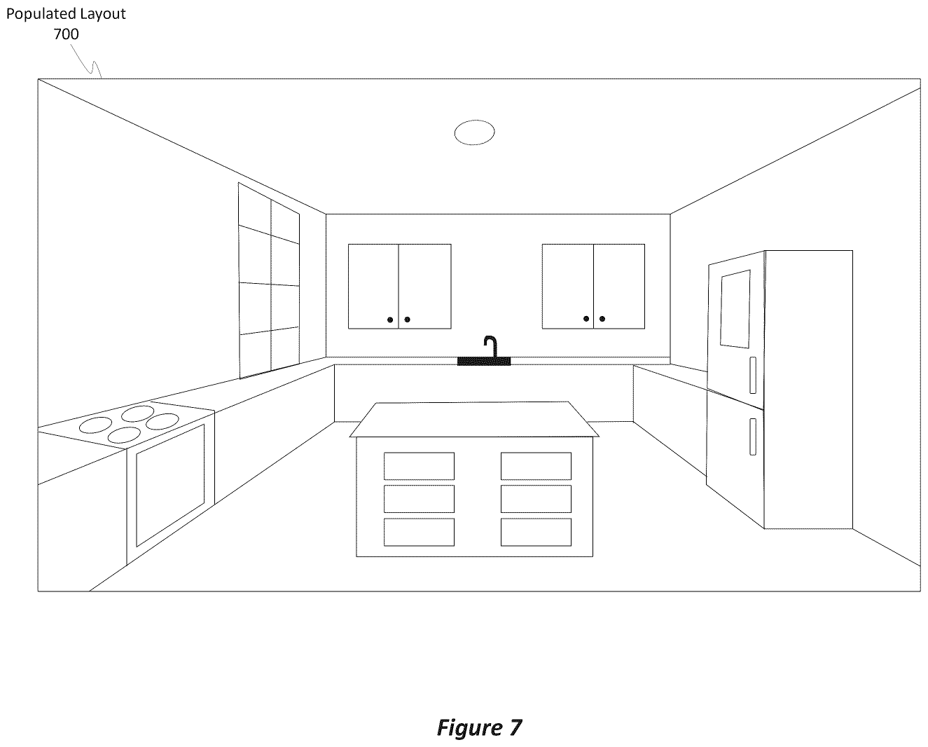

In this regard, service 105 is able to facilitate the generation of any number of different pre-defined templates. Service 105 can then receive the design constraints for a spatial layout. Service 105 can generate a digital twin for the spatial layout, select one of the pre-defined templates, and then automatically populate the digital twin with the selected template while also making automatic customizations to the placed template so as to better populate the digital twin. FIG. 7 shows an example perspective view of the populated layout 700, which is representative of the populated layout 605 from FIG. 6.

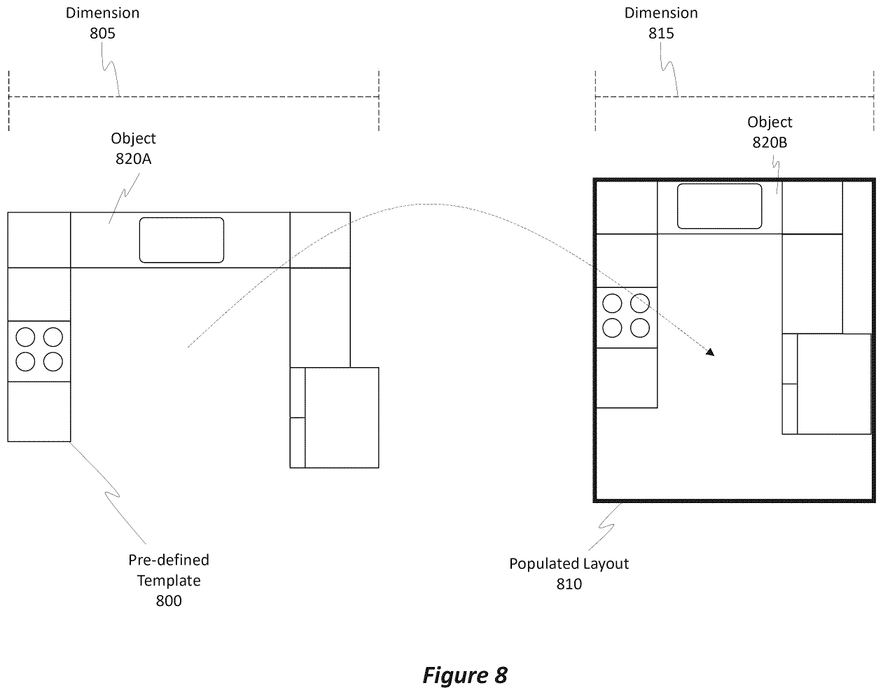

FIG. 8 shows another intelligent customization that can be made by service 105.

FIG. 8 shows a pre-defined template 800, which corresponds to the pre-defined template 600 of FIG. 6. Notice, the pre-defined template 800 includes a dimension 805.

FIG. 8 further shows a populated layout 810 in which a digital twin of a spatial layout was populated using the pre-defined template 800. Notice, the populated layout 810 has a dimension 815 that is different than the dimension 805 (e.g., the width is smaller). To account for this difference in size, service 105 modified the original size of a counter (e.g., object 820A) to be smaller, as shown now by object 820B, which has a smaller width than object 820A.

Returning to FIG. 1, service 105 is thus able to generate a populated layout 130. Service 105 is also able to facilitate various customizations 135 to that populated layout 130. In some cases, the customizations 135 are performed automatically by service 105, such as those discussed in FIGS. 6 and 8. In some cases, the customizations 135 are additionally or alternatively performed by a user who is interacting with service 105 to make those customizations 135. For instance, the populated digital twin can be displayed in a user interface provided by service 105. The user can make the customizations 135 by entering user input via this user interface. Thus, service 105 is able to facilitate parametric changes to the populated layout 130.

### Containers

Service 105 is also able to support so-called “containers,” as shown by container(s) 140. As used herein, a “container” refers to a defined volume comprising one or more objects. A container can be large, such as spanning the size of an entire room, small, such as spanning a small drawer, or any size in-between. Typically, a container includes at least one object, such as a drawer, cabinet, fridge, sink, pantry, light assembly, or any other object. A container can include multiple objects and combinations of different objects, such as a sink object combined with a counter object, a cupboard object, and a drawer object. Any number of objects can be included in a container.

The shape of a container need not be uniform, and any shape can be used. Volumes within a container can be carved out to accommodate other containers. For instance, initially consider a cube-shaped container. A smaller cube shape can be carved out of this larger cube, and the smaller cube can be designed for a different container.

In this manner, a container is a programming entity that represents one or a collection of multiple objects (e.g., cabinets, shelves, or other architecturally integrated elements). Containers are configured to allow for customization and other details, such as the inclusion of a kick (e.g., a space near the floor to fill an open region) or a sub-counter that is shared among multiple other objects. An individual container can be included in a group of multiple containers. For instance, a first container may include a set of drawers. This first container can be included in a larger group of containers that form a kitchen island, peninsula, or a wall run, as various examples.

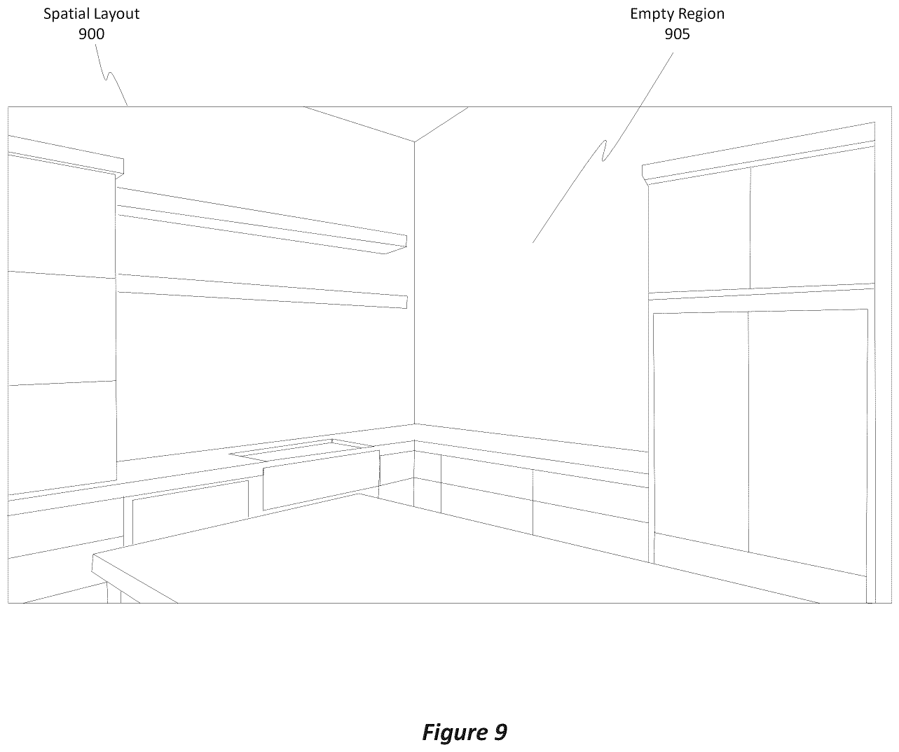

Service 105 includes intelligence so as to auto-generate or auto-populate a container based on various design considerations. This container can then later be subjected to parametric editing. For instance, service 105 can auto-generate one or more cabinets to fill a container based on a defined type for that container. Service 105 is further able to automatically generate other managed products, such as island seating support, end panels, and others using a container. Service 105 can also automatically generate so-called “reveals” (to be discussed in more detail later) and facilitate changes to a panel's size. Service 105 can also automatically generate countertops for containers. Indeed, service 105 can generate any type of object for a container. Even though a container might include multiple objects, the container as a whole can be operated on in a parametric manner, such as by moving the entire container or by resizing or reshaping the container. Rotations, translations, and scaling can also be performed. Modifications to the container might result in changes to each individual object's size, position, orientation, and so on. FIGS. 9 through 18 provide additional details regarding containers.

FIG. 9 shows an example spatial layout 900 that includes an empty region 905 in which an object or a container can be placed. Spatial layout 900 can be displayed in a user interface, and a user can make design arrangements so as to populate the empty region 905 with predefined containers and/or containers made on-the-fly.

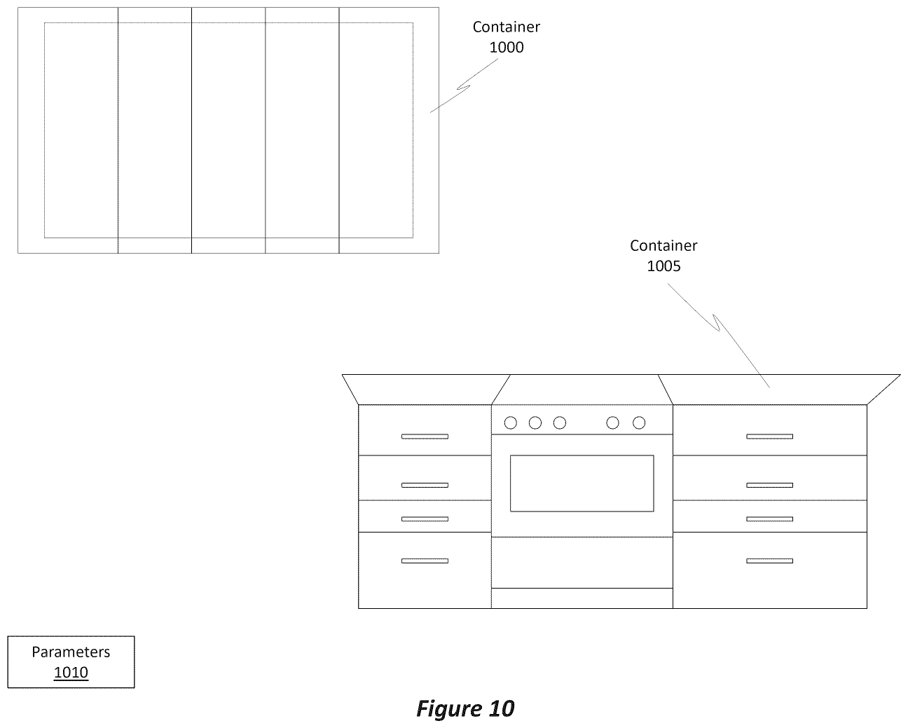

FIG. 10 shows two examples of containers, namely container 1000 (i.e. in the form of multiple cabinets) and container 1005 (i.e. in the form of an oven, stove, multiple drawers, and multiple countertops). A user interacting with service 105 can define various parameters 1010 for the different containers. These parameters 1010 may include parametric based parameters, such as when a parametric change occurs to the containers, those changes must adhere to the parametric parameters. The parameters 1010 may be more granular as well, such as characteristics or parameters for each individual object in the container.

Regarding container 1000, this container currently includes five different cupboards. An example of a parametric parameter may be that no cupboard is to exceed a certain size dimension. If the overall size of the container 1000 is increased, then instead of increasing the sizes of the individual cupboards beyond the threshold size, service 105 may add a new cupboard to the container 1000. An example of an individual object parameter can be a color characteristic. Often, cupboards are all the same color, but it might be the case that an owner would like different colored cupboards. Of course, color is but one example of a parameter. Other parameters can also be used.

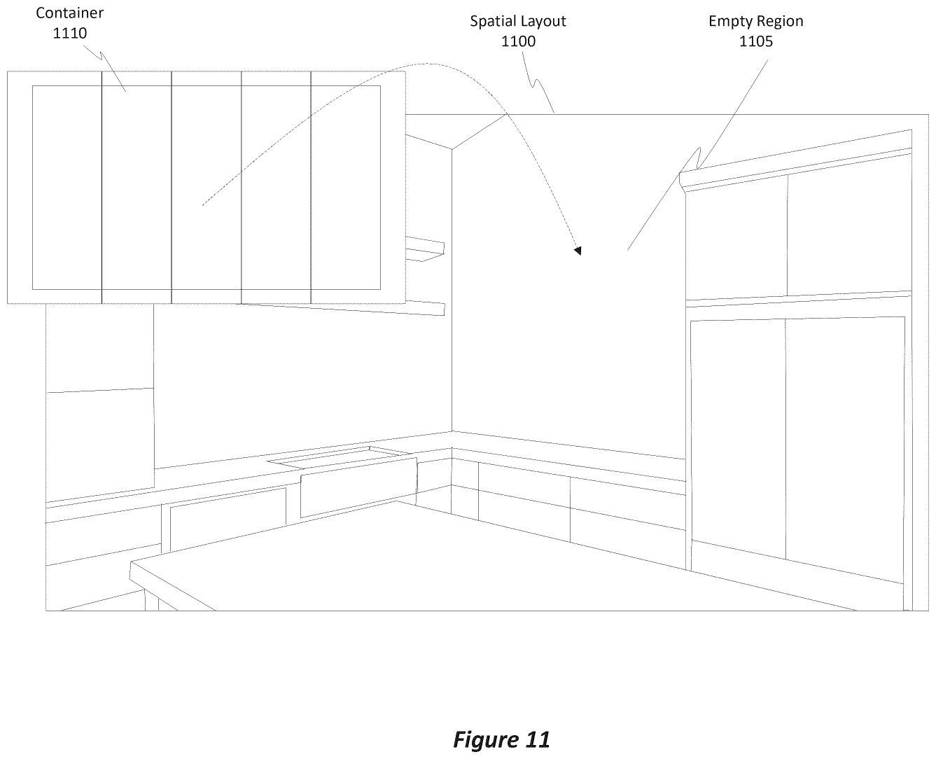

FIG. 11 again shows the spatial layout 1100 and the empty region 1105. By interacting with the user interface provided by service 105, a user can add the container 1110 to the spatial layout 1100 so as to fill the empty region 1105, as shown by the drag and drop action in FIG. 11.

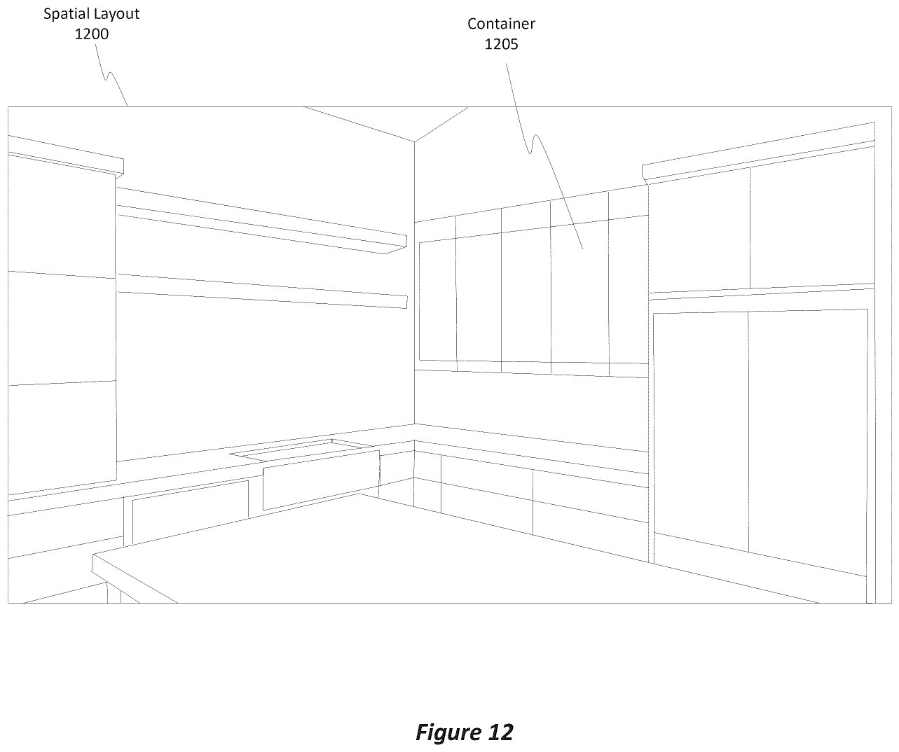

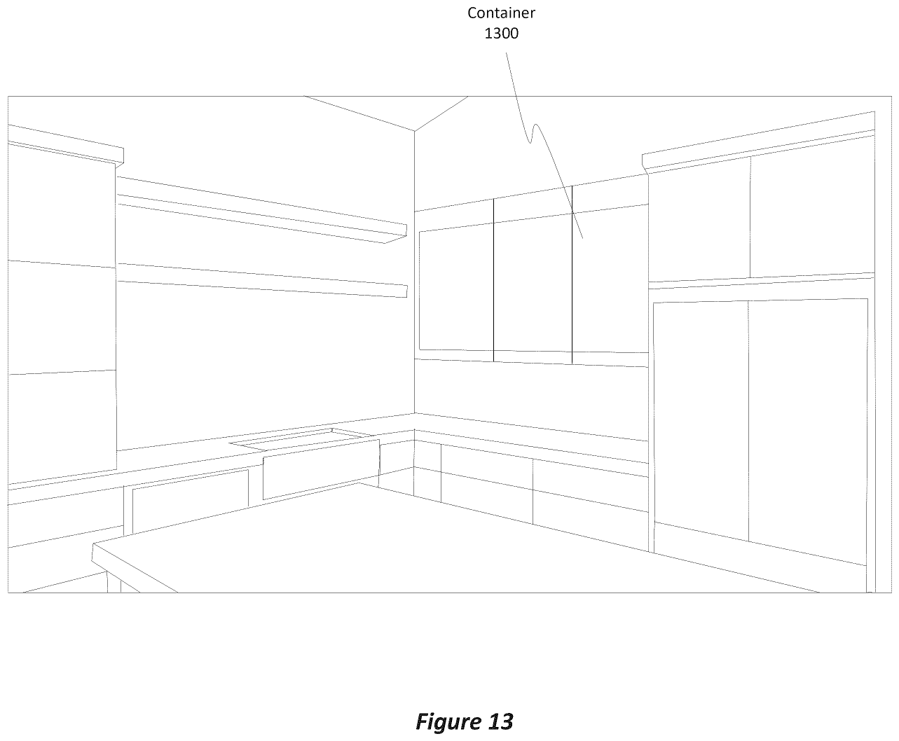

FIG. 12 shows the spatial layout 1200. The spatial layout 1200 now includes the container 1205 that was previously added. Notice, the container 1205 still includes 5 different cupboards. FIG. 13, on the other hand, demonstrates how further user customizations can be made to the container 1300. In this example scenario, the container 1300 is now configured to include only 3 cupboards. These customizations can occur by modifying the parameters of a container.

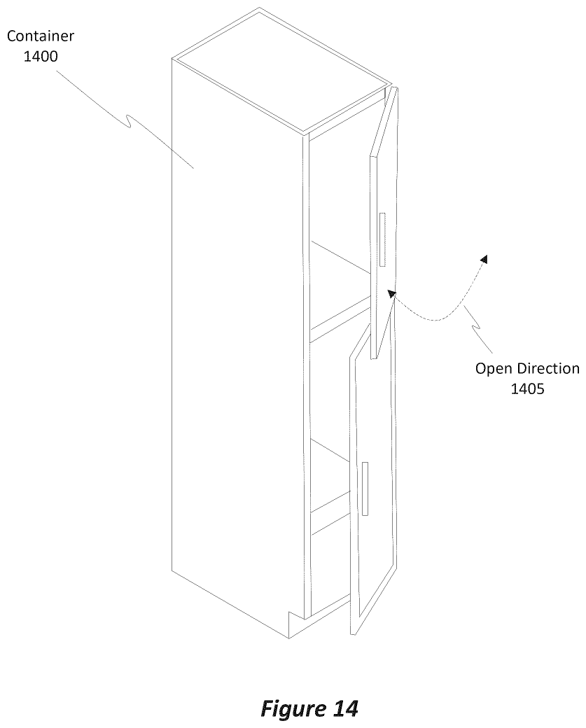

FIG. 14 shows another example container 1400 comprising two separate storage compartments with corresponding doors. Notice, the placement of the hinges for the doors is set to the right hand position, resulting in the open direction 1405 for the doors opening outward and towards the right.

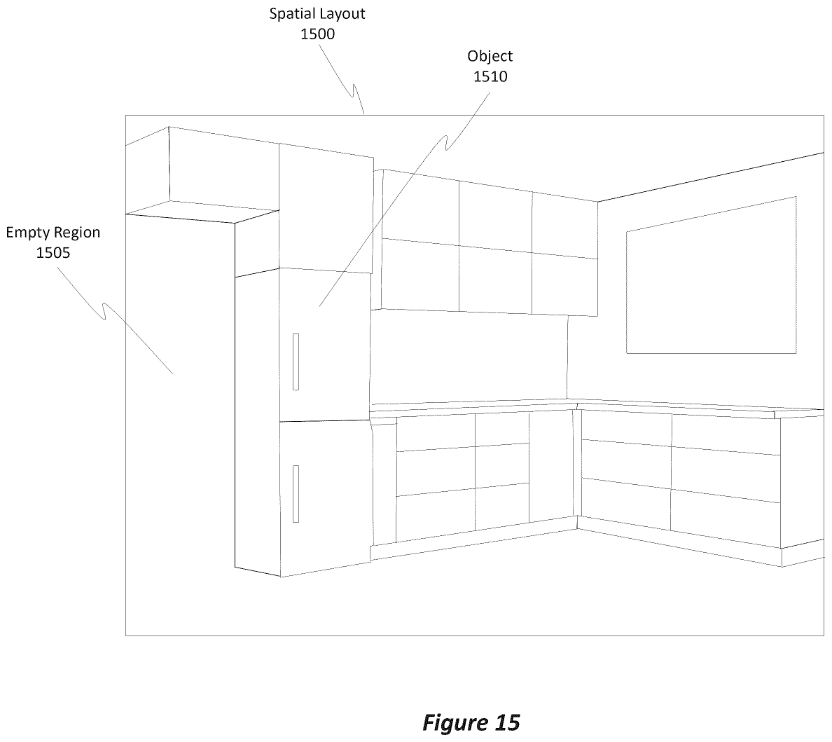

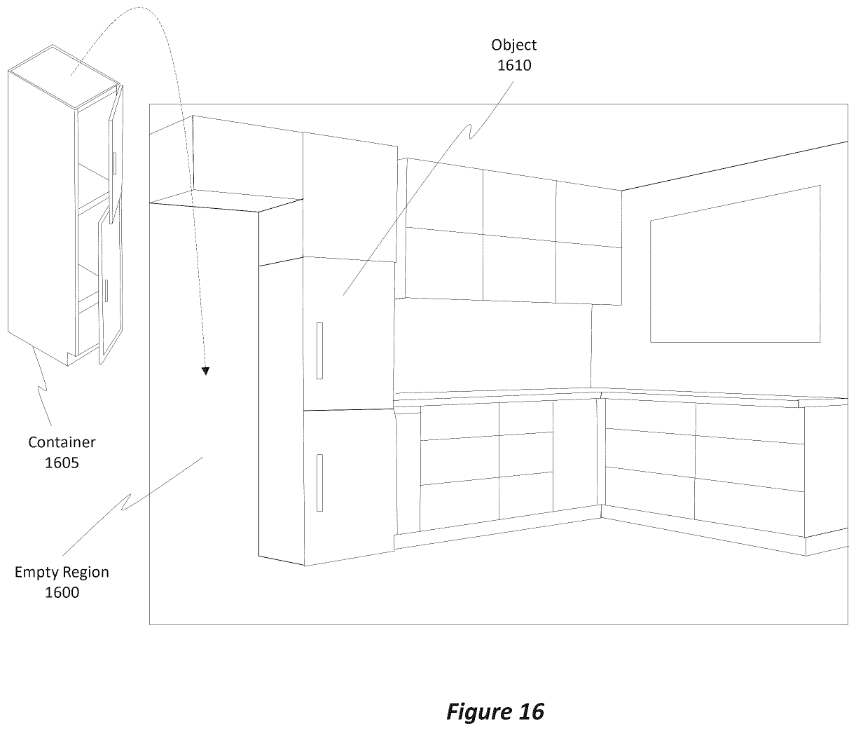

FIG. 15 shows a spatial layout 1500 comprising an empty region 1505 and an object 1510 (e.g., a fridge). A user may desire to place the container 1400 of FIG. 14 into the empty region 1505, as shown in FIG. 16.

FIG. 16 shows the empty region 1600. Now, a user is interacting with the service 105 to place the container 1605 into the empty region 1600 next to the object 1610.

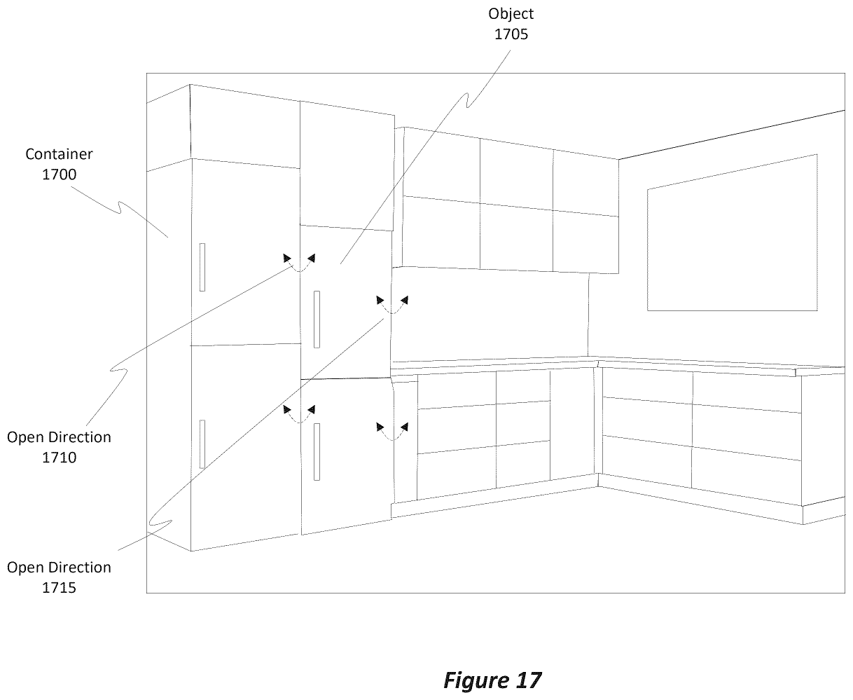

FIG. 17 now shows the container 1700 in place next to the object 1705. The open direction 1710 for the doors of container 1700 is shown. Similarly, the open direction 1715 for the object 1705 is also shown. In a scenario where the object 1705 is a fridge, or some other less-changeable object, the open direction 1710 of the container 1700 might interfere with the door of the fridge. For instance, as the door of the container 1700 swings outward to the right, the hinge portion of the door might contact and thus impede the door of the fridge.

In accordance with the disclosed principles, service 105 is able to analyze the positional relationships between different objects that are proximate to one another or are within a threshold distance to one another (e.g., consider an oven door being within a threshold distance to an island). This analysis includes whether one object, during its use, might impede another object. Using the oven door example, the island will need to be sufficiently far away from the oven door so as to not impede the oven door when it is opened. Service 105 can perform this analysis and determine when a collision, obstruction, or design impediment might occur. In the scenario shown in FIG. 17, the doors of the container 1700 will likely impede the doors of the object 1705.

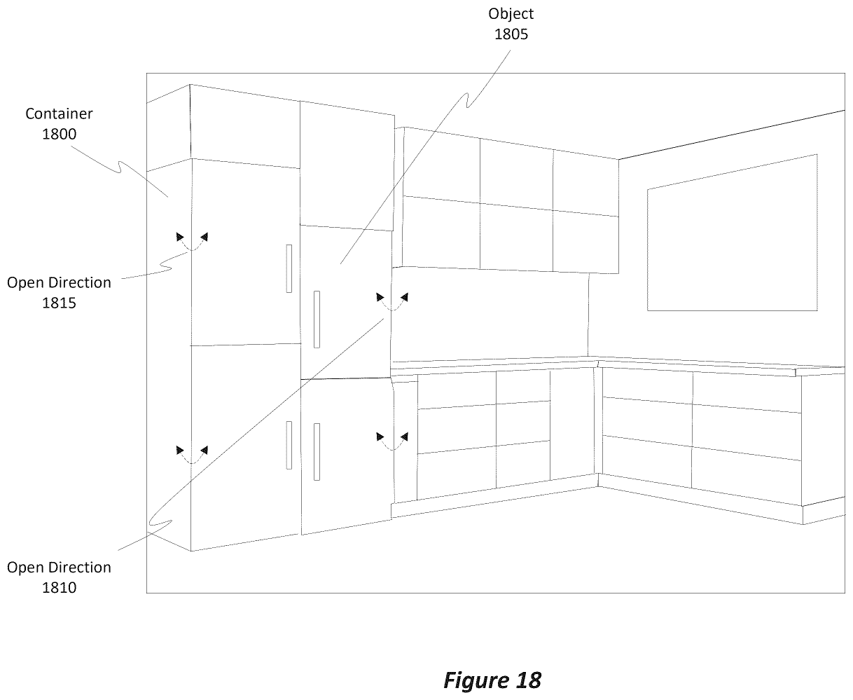

Based on that analysis, service 105 can recommend or automatically perform one or more corrections to as to resolve the potential impediments. Such a scenario is shown in FIG. 18.

FIG. 18 shows the container 1800 and the object 1805. The doors of object 1805 still open in the same direction, as shown by open direction 1810, because object 1805 is one that is typically not readily configurable (e.g., such as a fridge). On the other hand, the doors of the container 1800 have been modified so they open in a new direction, as shown by open direction 1815. Service 105 analyzed the positional relationship between container 1800 and object 1805 and determined that container 1800 is more easily modifiable as compared to object 1805 based on their respective characteristics. Service 105 also determined that modifying the door opening direction of container 1800 would solve the impediment issue identified earlier.

### Reveals

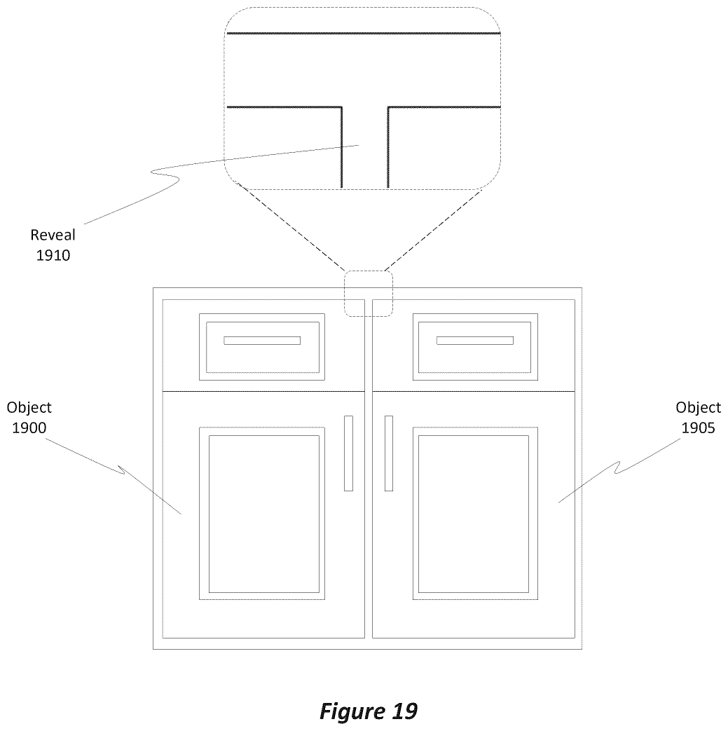

As shown in FIG. 1, service 105 is also able to generate and modify a reveal 145 for any type of object. As used herein, the term “reveal” refers to a spacing arrangement (e.g., a dynamically modifiable gap) between one object and another object. As an example, consider a scenario involving French doors. With French doors, the two doors have hinges on the outer sides of the doors, such that they close inward toward one another. When closed, a small gap exists between the two doors. This gap allows the doors to open and close freely without impediment. If the gap did not exist, it would be a significant challenge to open and close the doors because they would be in contact with one another. This gap is referred to herein as a “reveal.” FIG. 19 provides another helpful example.

FIG. 19 shows two objects, namely object 1900 and object 1905. These objects are in the form of cabinets with doors that open in the same manner as the French door example. For instance, the handles of the doors are shown as being close to one another near the middle.

FIG. 19 further shows the reveal 1910 that exists between the two doors. The reveal 1910 is the amount of empty space that exists between the two doors. This empty space is purposefully designed to enable the doors to open and close without encumbrance. In accordance with the disclosed principles, service 105 is able to dynamically modify the reveal 1910 based on various parameters, including the types of objects that are associated with the reveal.

Consider, for example, the scenario that was presented in FIG. 17, which involved a fridge and a cabinet. If, due to certain design constraints, the doors of the container 1700 could not be modified and had to be opened in the open direction 1710. As mentioned previously, this situation would likely cause impediments to opening the doors of the object 1705.

Service 105 is able to analyze the design situation and make various recommendations. Previously, the recommendation was to shift the alignment or positioning of the doors of the container 1700 to open in a different direction. Alternatively, service 105 can recommend modifying the reveal between the container 1700 and the object 1705. For instance, if the size of the reveal between the container 1700 and the object 1705 were increased in size, resulting in the hinge of the container 1700 being farther away from the door of the object 1705, then no impediment might exist because both the container's door and the object's door could open and close freely.

Thus, in some scenarios, service 105 is able to determine types for multiple different objects. Service 105 can also determine operational characteristics for those objections (e.g., the open and close path, the positional relationship, the presence of impediments, etc.). Based on that determined information, service 105 can dynamically modify the reveal that exists between multiple objects so as to promote or enhance the operational relationship that exists between those objects due to their proximity to one another.

Stated differently, service 105 facilitates the automatic generation of reveals, such as by modifying panel sizes. A “reveal” is a gap between two or more objects (e.g., cabinet doors or drawer fronts). Often, the default size of a reveal is about ⅛″. In some scenarios, that ⅛″ gap can be created by taking 1/16″ off both fronts (i.e. both objects). In some scenarios, that ⅛″ gap is removed from only one object (e.g., removed from a cabinet door but not a proximate fridge). In some scenarios, more than ⅛″ can be removed due to some limitation of a given object. Conventionally, the reveal is specified manually. The disclosed embodiments, on the other hand, are able to automate the sizing of the reveal based on rules and relationships of objects.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

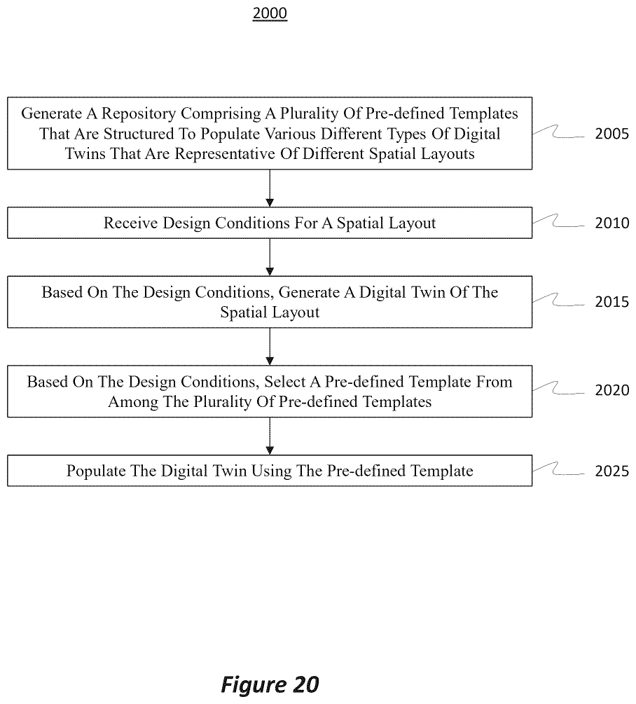

Attention will now be directed to FIG. 20, which illustrates a flowchart of an example method 2000 for populating a digital twin that is representative of a spatial layout (e.g., perhaps a kitchen layout) by parametrically modifying a pre-defined template having characteristics that satisfy design conditions for the spatial layout. Method 2000 can be implemented within the architecture 100 of FIG. 1. Furthermore, method 2000 can be performed by service 105.

Method 2000 includes an act (act 2005) of generating a repository comprising a plurality of pre-defined templates that are structured to populate various different types of digital twins that are representative of different spatial layouts. Each pre-defined template in the plurality of pre-defined templates has a corresponding theme and includes a corresponding set of objects that supplement said corresponding theme. The theme might limit which objects can be included in the template. In some cases, any object can be included in a template despite the theme, but elevated permissions might be required for that object's inclusion if it is one that is not normally included in a specific theme (e.g., an office desk is normally not included in a kitchen).

In some cases, a first pre-defined template in the plurality of pre-defined templates has a theme corresponding to a kitchen spatial layout. In some cases, a second pre-defined template in the plurality of pre-defined templates has a theme corresponding to a living room spatial layout, and a third pre-defined template in the plurality of pre-defined templates has a theme corresponding to an office spatial layout. In some cases, one of the pre-defined templates has a theme corresponding to a bedroom spatial layout while another one of the pre-defined templates has a theme corresponding to a bathroom spatial layout. When the pre-defined template is implemented as a kitchen template, the kitchen template may include one, some, or all of the following objects: a countertop object, an oven and stove object, a fridge object, a cabinet object, a lighting fixture, a sink object, and a drawer object.

Subsequent to generation of the repository comprising the plurality of pre-defined templates, act 2010 includes receiving design conditions for a spatial layout (e.g., perhaps a kitchen layout). The design conditions include spatial dimensions for the spatial layout and a particular theme (e.g., perhaps a kitchen theme) for the spatial layout. Optionally, the spatial layout corresponds to a kitchen area, and the particular theme for the spatial layout is a kitchen theme. The particular theme can dictate that whatever pre-defined template is used to populate a digital twin must include objects having certain defined types. For instance, if the digital twin corresponds to a kitchen, then the theme may cause kitchen-related objects to be used for the pre-defined template.

Based on the design conditions, act 2015 includes generating a digital twin of the spatial layout. The digital twin is structured to have characteristics representative of the design conditions, including the spatial dimensions and the particular theme. For instance, the digital twin can visually represent, within the user interface, the physical and spatial layout of a given area. That layout may include the presence of walls, windows, doors, ceilings, floors, and/or any other physical feature or obstruction.

Based on the design conditions, act 2020 includes selecting a pre-defined template (e.g., perhaps a kitchen template) from among the plurality of pre-defined templates. The selected pre-defined template is selected as a result of the corresponding set of characteristics for the pre-defined template satisfying, within a threshold level of satisfaction, the design conditions. For instance, suppose the pre-defined template has 10 characteristics, such as a color scheme, a layout (e.g., perhaps a U-shaped kitchen), a group of certain appliances, a specific amount of countertop surface area, an island, certain lighting fixture attributes, a floor characteristic, a placement of windows relative to other objects, a minimum number of drawers, a pantry, and/or a minimum number of cabinets. To satisfy the threshold level of satisfaction, it might be the case that the pre-defined template must have a minimum number of characteristics that match, align, or otherwise correspond with characteristics recited in the design conditions. For instance, the design conditions may require a threshold amount of surface area for countertops. The design conditions might require a specific kitchen layout, such as a U-shaped layout. If a threshold number of the characteristics of the pre-defined template match the requirements in the design conditions, then the pre-defined template may be selected.

In some implementations, the corresponding set of objects for the selected pre-defined template includes one or more of: an oven appliance object, a fridge appliance object, a countertop object, objects corresponding to a plurality of cabinets, a sink object, and objects corresponding to a plurality of drawers. If the template is for a bedroom, the objects may include, a bed object, a dresser object, an end table object, and so on. If the template is for a bathroom, the objects may include a sink object, a bathtub object, a toilet object, and so on. If the template is for an office, the objects may include a desk object, a chair object, a bookcase object, and so on.

Act 2025 includes populating the digital twin using the pre-defined template. The population process includes performing one or more parametric modifications to the pre-defined template. Optionally, the digital twin is displayed on a user interface, and the user interface further displays the pre-defined template prior to the pre-defined template being used to populate the digital twin. The pre-defined template, after being used to populate the digital twin, is customizable by a user.

In some cases, the one or more parametric modifications includes a parametric modification to a group of cabinets, resulting in a number of the cabinets in the group changing. In some cases, the one or more parametric modifications includes a parametric modification to a group of cabinets, resulting in sizes of the cabinets in the group changing. In some cases, the one or more parametric modifications includes a parametric modification to a kitchen island, resulting in a size of the kitchen island changing and further resulting in a number of drawers associated with the kitchen island changing (or the sizes of those drawers changing). The one or more parametric modifications may include adding one or more new objects to the pre-defined template. The one or more parametric modifications may include removing one or more existing objects from the pre-defined template.

In some cases, the one or more parametric modifications includes collectively modifying sizes of multiple objects included within the pre-defined template. The one or more parametric modifications may also include reducing a size of a first object included within the pre-defined template while increasing a size of a second object included within the pre-defined template. The one or more parametric modifications may also include reducing sizes of a first group of objects included within the pre-defined template while increasing sizes of a second group of objects included within the pre-defined template. In this manner, a pre-defined template can be parametrically modified to accommodate a digital twin representative of a spatial layout.

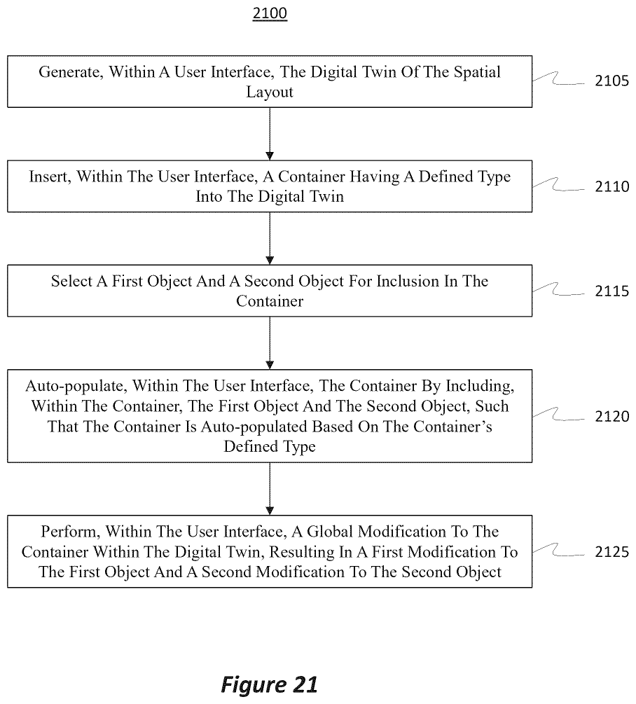

Attention will now be directed to FIG. 21, which illustrates a flowchart of an example method 2100 for generating a container that includes one or more objects. The container is insertable into a digital twin of a spatial layout to populate the digital twin with the one or more objects. Method 2100 can also be implemented within the architecture 100 of FIG. 1. Additionally, method 2100 can be performed by service 105.

Method 2100 includes an act (act 2105) of generating, within a user interface, the digital twin of the spatial layout. This digital twin digitally represents, in a proportional manner, the physical attributes of an area.

Act 2110 includes inserting, within the user interface, a container having a defined type into the digital twin. The container is configured to include one or more objects whose characteristics correspond with the defined type of the container such that the defined type of the container operates as a filter in determining which objects are permitted to be included in the container. The container can define a volume within the digital twin. As one example, suppose the container is an island for a kitchen area. Islands typically do not include office desks. As a result, the island type definition for this container can optionally limit which objects can be included in the container. The user interface can display a selectable listing of different objects. The container's type can optionally operate as a filtering mechanism to that list of objects.

Act 2115 includes selecting a first object and a second object for inclusion in the container. The first and second objects have characteristics that correspond with the defined type of the container. The first and second objects are displayed in the user interface. The first and second objects are included in a set of multiple objects that are selectable within the user interface.

Act 2120 includes auto-populating, within the user interface, the container. This auto-population is performed by including, within the container, the first object and the second object, such that the container is auto-populated based on the container's defined type. In this manner, service 105 of FIG. 1 can automatically generate and populate the container with any number of objects.

Act 2125 includes performing, within the user interface, a global modification to the container within the digital twin. This global modification results in a first modification to the first object and a second modification to the second object. Optionally, the global modification includes one or more of the following: a movement/translation of the container to a new position within the digital twin, a scaling of the container, or a rotation of the container.

In some scenarios, the digital twin is representative of a kitchen spatial area. Further, the container can be a cabinet type of container. Optionally, method 2100 may further include generating a countertop object that is disposed overtop of the container. In some cases, the countertop object can be included in the container. In other cases, the countertop can be a separate container.

In some cases, the defined type for the container is a cabinet type such that the first object is a first cabinet, and the second object is a second cabinet. In some cases, the defined type is an island type. Optionally, the first object may be a first drawer, and the second object may be a second drawer. In some cases, a third object is shareable between the first object and the second object. As various examples, the first object may be a first drawer, the second object may be a second drawer. The third object can then be a countertop, and the countertop is shared between the first drawer and the second drawer. By “shared,” it is generally meant that a portion of the third object covers, overlaps, or is otherwise associated with the first object, and a separate portion of the third object covers, overlaps, or is otherwise associated with the second object.

In some cases, the container is one container included among a group of containers. Optionally, the digital twin can represent a kitchen spatial layout, and the group of containers can form an island object in the digital twin. Optionally, the digital twin may represent a kitchen spatial layout, and the container can form an island seating support object for an island object of the digital twin. Of course, other constructs can be formed, including ones that are not part of a kitchen but rather are parts of a bedroom, living room, office, bathroom, or any other spatial region.

In some implementations, a reveal is included between the first object and the second object in the container. The reveal can be designed to have a specified size. In some cases, a portion of the first object is configured to accommodate at least a part of the specified size. For instance, if the first object is a door, the size and/or positioning of the door can be modified to accommodate the size of the reveal.

In some cases, portions of both the first object and the second object are configured to accommodate the specified size. For instance, if both objects are doors, the sizes and/or positioning of the doors can be modified to accommodate the size of the reveal.

In some cases, a portion of only the first object is configured to accommodate the specified size. For instance, suppose the first object is a door, but the second object is a fridge. The fridge is generally not modifiable, but the door is. Thus, in this scenario, only the door is modified. Optionally, the specified size of the reveal may be based on a first type of the first object and a second type of the second object.

Regarding the global modifications, in some cases, the global modification (e.g., a parametric change) to the container includes a resize of the container, resulting in resizing of the first and second objects. In some cases, the global modification to the container includes a resize of the container, and resizing the container results in an automatic addition of a third object to the container.

### Example Computer/Computer Systems

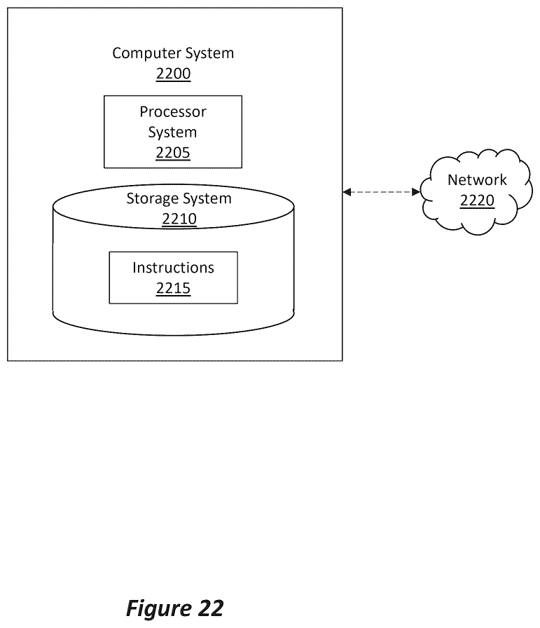

Attention will now be directed to FIG. 22 which illustrates an example computer system 2200 that may include and/or be used to perform any of the operations described herein. Computer system 2200 may take various different forms. For example, computer system 2200 may be embodied as a tablet, a desktop or a laptop, a wearable device, a mobile device, or any other standalone device. Computer system 2200 may also be a distributed system that includes one or more connected computing components/devices that are in communication with computer system 2200. Computer system 2200 can implement the computing architecture 100 of FIG. 1.

In its most basic configuration, computer system 2200 includes various different components. FIG. 22 shows that computer system 2200 includes a processor system 2205 that includes one or more processor(s) (aka a “hardware processing unit”) and a storage system 2210.

Regarding the processor(s) of the processor system 2205, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 2200. The different components, modules, engines, and services described herein may be implemented as objects or processors that execute on computer system 2200 (e.g. as separate threads).

Storage system 2210 may be physical system memory, which may be volatile, non-volatile, or some combination of the two. The term “memory” may also be used herein to refer to non-volatile mass storage such as physical storage media. If computer system 2200 is distributed, the processing, memory, and/or storage capability may be distributed as well.

Storage system 2210 is shown as including executable instructions 2215. The executable instructions 2215 represent instructions that are executable by the processor(s) of computer system 2200 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 2200 may also be connected (via a wired or wireless connection) to external sensors (e.g., one or more remote cameras) or devices via a network 2220. For example, computer system 2200 can communicate with any number devices or cloud services to obtain or process data. In some cases, network 2220 may itself be a cloud network. Furthermore, computer system 2200 may also be connected through one or more wired or wireless networks to remote/separate computer systems(s) that are configured to perform any of the processing described with regard to computer system 2200.

A “network,” like network 2220, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 2200 will include one or more communication channels that are used to communicate with the network 2220. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for populating a digital twin that is representative of a spatial layout by parametrically modifying a pre-defined template having characteristics that satisfy design conditions for the spatial layout, said method comprising:
generating a repository comprising a plurality of pre-defined templates that are structured to populate various different types of digital twins that are representative of different spatial layouts, wherein each pre-defined template in the plurality of pre-defined templates has a corresponding theme and includes a corresponding set of objects that supplement said corresponding theme;
subsequent to generation of the repository comprising the plurality of pre-defined templates, receiving design conditions for a spatial layout, wherein the design conditions include spatial dimensions for the spatial layout and a particular theme for the spatial layout;
based on the design conditions, generating a digital twin of the spatial layout, wherein the digital twin is structured to have characteristics representative of the design conditions, including the spatial dimensions and the particular theme;
based on the design conditions, selecting a pre-defined template from among the plurality of pre-defined templates, wherein the selected pre-defined template is selected as a result of the corresponding set of characteristics for the pre-defined template satisfying, within a threshold level of satisfaction, the design conditions; and
populating the digital twin using the pre-defined template, wherein said populating includes performing one or more parametric modifications to the pre-defined template.

2. The method of claim 1, wherein a first pre-defined template in the plurality of pre-defined templates has a theme corresponding to a kitchen spatial layout.

3. The method of claim 2, wherein a second pre-defined template in the plurality of pre-defined templates has a theme corresponding to a living room spatial layout, and wherein a third pre-defined template in the plurality of pre-defined templates has a theme corresponding to an office spatial layout.

4. The method of claim 1, wherein the corresponding set of objects for the selected pre-defined template includes one or more of: an oven appliance object, a fridge appliance object, a countertop object, objects corresponding to a plurality of cabinets, and objects corresponding to a plurality of drawers.

5. The method of claim 1, wherein the spatial layout corresponds to a kitchen area, and wherein the particular theme for the spatial layout is a kitchen theme.

6. The method of claim 1, wherein the digital twin is displayed on a user interface, and wherein the user interface further displays the pre-defined template prior to the pre-defined template being used to populate the digital twin.

7. The method of claim 1, wherein the one or more parametric modifications includes a parametric modification to a group of cabinets, resulting in a number of the cabinets in the group changing.

8. The method of claim 1, wherein the one or more parametric modifications includes a parametric modification to a group of cabinets, resulting in sizes of the cabinets in the group changing.

9. The method of claim 1, wherein the one or more parametric modifications includes a parametric modification to a kitchen island, resulting in a size of the kitchen island changing and further resulting in a number of drawers associated with the kitchen island changing.

10. The method of claim 1, wherein the one or more parametric modifications includes adding one or more new objects to the pre-defined template.

11. The method of claim 1, wherein the one or more parametric modifications includes removing one or more existing objects from the pre-defined template.

12. A computer system comprising:
a processor system; and
a storage system that stores instructions that are executable by the processor system to cause the computer system to:
generate a repository comprising a plurality of pre-defined templates that are structured to populate various different types of digital twins that are representative of different spatial layouts, wherein each pre-defined template in the plurality of pre-defined templates has a corresponding theme and includes a corresponding set of objects that supplement said corresponding theme;
subsequent to generation of the repository comprising the plurality of pre-defined templates, receive design conditions for a spatial layout, wherein the design conditions include spatial dimensions for the spatial layout and a particular theme for the spatial layout;
based on the design conditions, generate a digital twin of the spatial layout, wherein the digital twin is structured to have characteristics representative of the design conditions, including the spatial dimensions and the particular theme;
based on the design conditions, select a pre-defined template from among the plurality of pre-defined templates, wherein the selected pre-defined template is selected as a result of the corresponding set of characteristics for the pre-defined template satisfying, within a threshold level of satisfaction, the design conditions; and
populate the digital twin using the pre-defined template, wherein said populating includes performing one or more parametric modifications to the pre-defined template.

13. The computer system of claim 12, wherein a first pre-defined template in the plurality of pre-defined templates has a theme corresponding to a bedroom spatial layout, and wherein a second pre-defined template in the plurality of pre-defined templates has a theme corresponding to a bathroom spatial layout.

14. The computer system of claim 12, wherein the one or more parametric modifications includes collectively modifying sizes of multiple objects included within the pre-defined template.

15. The computer system of claim 12, wherein the one or more parametric modifications includes reducing a size of a first object included within the pre-defined template while increasing a size of a second object included within the pre-defined template.

16. The computer system of claim 12, wherein the one or more parametric modifications includes reducing sizes of a first group of objects included within the pre-defined template while increasing sizes of a second group of objects included within the pre-defined template.

17. The computer system of claim 12, wherein the pre-defined template, after being used to populate the digital twin, is customizable by a user.

18. The computer system of claim 12, wherein the particular theme dictates that whatever pre-defined template is used to populate the digital twin must include objects having certain defined types.

19. A method for populating a digital twin that is representative of a kitchen layout by parametrically modifying a pre-defined template having characteristics that satisfy design conditions for the kitchen layout, said method comprising:
accessing a repository comprising a plurality of pre-defined templates that are structured to populate various different types of digital twins that are representative of different spatial layouts, wherein each pre-defined template in the plurality of pre-defined templates has a corresponding theme and includes a corresponding set of objects that supplement said corresponding theme;
receiving design conditions for a kitchen layout, wherein the design conditions include spatial dimensions for the kitchen layout and a kitchen theme for the kitchen layout;
based on the design conditions, generating a digital twin of the kitchen layout, wherein the digital twin is structured to have characteristics representative of the design conditions, including the spatial dimensions and the kitchen theme;
based on the design conditions, selecting a pre-defined template from among the plurality of pre-defined templates, wherein the selected pre-defined template is a kitchen template that is selected as a result of the corresponding set of characteristics for the kitchen template satisfying, within a threshold level of satisfaction, the design conditions; and
populating the digital twin using the kitchen template, wherein said populating includes performing one or more parametric modifications to the kitchen template.

20. The method of claim 19, wherein the kitchen template includes all of the following objects: a countertop object, an oven and stove object, a fridge object, a cabinet object, and a drawer object.
